(19) United States
(12) Patent Application Publication
(10) Pub. No.: US 2026/0166590 A1
(43) Pub. Date: Jun. 18, 2026

(54) Robotic System and Method for Picking and/or Sorting Objects

(71) Applicant: DANU ROBOTICS LTD, Musselburgh (GB)

(72) Inventors: Xiaoyan Ma, Musselburgh (GB); Nathan Western, Musselburgh (GB)

(21) Appl. No.: 18/708,118

(22) PCT Filed: Nov. 9, 2022
(86) PCT No.: PCT/GB2022/052834

§ 371 Date: May 7, 2024

(30) Foreign Application Priority Data
Nov. 9, 2021 (GB) 2116109.6
Aug. 11, 2022 (GB) 2211779.0

(51) Int. Cl. B07C 5/36; B25J 9/00; B25J 9/08; B25J 9/16

(52) U.S. Cl. CPC B07C 5/362; B25J 9/0093; B25J 9/08; B25J 9/1697; B07C 2501/0063

(57) ABSTRACT

A robotic system (10) for picking and/or sorting objects comprises a collaborative robotic picker arrangement (20) operatively associated with a conveyor (14) for conveying objects to be sorted. The robotic picker arrangement (20) comprises a plurality of robotic pickers (22a, 22b) each configured to pick up a selected one or more of said objects from the conveyor (14) and a processing system (24). The processing system (24) is configured to receive sensor data relating to the objects being conveyed by the conveyor (14) from a sensor arrangement (30) forming part of, coupled to or operatively associated with the robotic system (10) and determine whether any one of the objects being conveyed by the conveyor (14) corresponds to a predetermined class of objects to be picked and/or sorted by the robotic system (10), and output one or more command signals to the robotic picker arrangement (20) to position one of said robotic pickers (22a; 22b) relative to the conveyor (14) to permit the allocated robotic picker (22a; 22b) to pick up the selected object to be picked and/or sorted from the conveyor (14).

### FIELD

This relates to a robotic system for picking and/or sorting objects and to a method for picking and/or sorting objects using the robotic system. In particular, but not exclusively, this relates to a robotic system suitable for use in picking and/or sorting waste items, e.g. in a material recovery facility, and to a method for picking and/or sorting such waste items using the robotic system.

### BACKGROUND

The processing of domestic waste items plays a key role in meeting environmental targets, e.g. by reducing the volumes of material sent to landfill and increasing the volume of materials for recycling and/or reuse.

However, the processing of domestic waste items on an industrial scale poses significant challenges.

For example, many waste management companies fall in the category of small to medium sized enterprises, and rely on manual operatives to pick and/or sort waste items.

While established/larger waste management companies can invest in material recovery facilities (MRFs) to process and recycle domestic waste, which may employ automation, MRFs still utilise human operatives in order to perform certain tasks.

One such area where human operatives are still currently utilised is at the beginning of the waste processing process, where operatives are needed to pick out contaminants such as tapes, wires, nappies and plastic bags.

Another area where human operatives are still currently utilised is at the end of the waste processing process, where operatives are needed to verify that different waste materials have been correctly sorted. If the wrong type of material is identified, workers are needed to pick this material out and place it in the correct bin, hopper or the like.

Both manual processes are profoundly inefficient and inevitably subject to human error, which can result in reduced recycling performance. Moreover, such manual processes pose a significant health risk to operatives working in the vicinity of the waste processing system, both in terms of proximity to machinery and in terms of potential exposure to hazardous materials.

At typical recycling facilities, there are currently very few performance metrics available to waste management companies in order to assess performance. One current metric is a comparison of the total weight of input material with the weight of recyclables that are produced at the end of the process. Another current metric is the purity level of recyclables generated, which is estimated by human observation. As such, there is typically neither a sufficient volume of information or accuracy to provide stakeholders with an appropriate understanding of the waste processing and/or recycling process.

### SUMMARY

Aspects of the present disclosure relate to a robotic system for picking and/or sorting objects and to a method for picking and/or sorting objects using the robotic system. In particular, but not exclusively, this relates to a robotic system suitable for use in picking and/or sorting waste items, e.g. in a material recovery facility, and to a method for picking and/or sorting such waste items using the robotic system.

According to a first aspect, there is provided a robotic system for picking and/or sorting objects, the system comprising:
a collaborative robotic picker arrangement operatively associated with a conveyor arrangement for conveying objects to be sorted,
wherein the robotic picker arrangement comprises a plurality of robotic pickers each configured to pick up a selected one or more of said objects from the conveyor arrangement; and
a processing system,
wherein the processing system is configured to receive sensor data relating to the objects being conveyed by the conveyor arrangement from a sensor arrangement forming part of, coupled to or operatively associated with the robotic system,
the processing system configured to interrogate said received sensor data using one or more object detection algorithms to determine from the received sensor data whether any one of the objects being conveyed by the conveyor arrangement corresponds to a predetermined class of objects to be picked and/or sorted by the robotic system,
wherein the processing system is configured to receive positional data relating to the object to be picked and/or sorted from the sensor arrangement and velocity data relating to the object to be picked and/or sorted from the sensor arrangement and/or the conveyor arrangement,
the processing system configured to interrogate said received positional and velocity data to determine a predicted position of the object to be picked and/or sorted as it passes the robotic picker arrangement, and
wherein the processing system is configured to output one or more command signals to the robotic picker arrangement to position one of said robotic pickers relative to the conveyor arrangement to permit said robotic picker to pick up the selected object to be picked and/or sorted from the conveyor arrangement.

In use, the robotic system is installed relative to a conveyor arrangement such that the robotic picker arrangement of the robotic system is capable of picking up objects from the conveyor arrangement. The processing system of the robotic system receives sensor data relating to the objects being conveyed by the conveyor arrangement from the sensor arrangement. The processing system of the robotic system then employs one or more object detection algorithms to the sensor data to determine whether any one of the objects being conveyed by the conveyor arrangement corresponds to a predetermined class of objects to be picked and/or sorted by the robotic system. The processing system also receives positional data relating to the object to be picked and/or sorted from the sensor arrangement and velocity data relating to the object to be picked and/or sorted from the sensor arrangement and/or the conveyor arrangement, which is processed by the processing system to determine the predicted position of the object to be picked and/or sorted as it passes the robotic picker arrangement. The processing system then outputs one or more command signals to the robotic picker arrangement to position one of said robotic pickers relative to the conveyor arrangement to permit said robotic picker to pick up the selected object to be picked and/or sorted from the conveyor arrangement.

The robotic system may comprise or take the form of an integrated robotic picking and/or sorting system, e.g. a central operating system of the robotic system may be configured and/or operable to communicate high level instructions to each of the plurality of robotic pickers and receive feedback from them.

The robotic system may comprise or take the form of a distributive robotic picking and/or sorting system, e.g. the robotic pickers each form a component part of the robotic system instead of being an independent robotic system.

The robotic system may comprise or take the form of a modular robotic picking and/or sorting system, e.g. each of the plurality of robotic pickers may have its own local operating system and may be configured and/or operable to execute instructions sent by the central operating system of the robotic system and/or communicate with the central operating system.

The robotic system provides a number of significant benefits compared to conventional systems and techniques for picking and/or sorting objects. For example, the system is operable as one, integrated, system to sort different items, e.g. waste items, simultaneously. Rather than a collection of independent robots, the robotic pickers of the robotic system work as an organised team. Amongst other things, this provides benefits in terms of the greater flexibility that the robotic system can offer in comparison to conventional systems and methods. Each individual robotic picker may have its own speciality and each robotic picker may be individually designed to perform a number of unique picking tasks.

For example, in the waste processing and recycling sector a picker may be specialised to pick out wires, tapes and plastic bags. Another picker may be designed to pick out nappies. Another picker maybe designed to pick out batteries or other e-waste.

It will be understood that the robotic system may be configured and/or operable to pick and/or sort objects in a variety of sectors, including for example but not exclusively the construction sector, the e-waste sector and/or the textile sector. In the construction sector, for example, the robotic system may be configured and/or operable to pick and/or sort objects such as: waste wood; tarpaulins; metal bars; metal box sections; and/or rubble. In the e-waste sector, for example, the robotic system may be configured and/or operable to pick and/or sort objects such as: printed circuit boards; valves; wires; and/or electrical components such as capacitors, resistors, diodes, etc. In the textile sector, for example, the robotic system may be configured and/or operable to pick and/or sort objects such as: cotton materials; nylon materials; synthetic fabric materials; hemp materials, uniforms; and/or accessories such as belts.

Moreover, the robotic system can have any number of robotic pickers as required and may be configured as required for processing certain types of objects, e.g. particular types of waste items. The robotic system may thus be readily scalable, e.g. having as many robotic pickers as required while still being one system. The provision of a distributive system also means that the picking tasks are distributed appropriately among the pickers with picking tasks assigned to pickers in line with each picker's speciality. As such, all pickers are performing tasks simultaneously and in parallel.

Since the processing system of the robotic system provides command signals to a plurality of robotic pickers, the robotic system is capable to operating the robotic pickers collaboratively. This facilitates a greater capacity in terms of the volume of objects that can be picked and/or sorted and/or a greater capacity in terms of the types of objects that can be picked and/or sorted at one time.

While each of the robotic pickers may be assigned a single class of objects to be picked and/or sorted, the provision of a collaborative robotic picker arrangement means that each of the robotic pickers can be assigned a plurality of classes of objects to be picked and/or sorted.

In particular embodiments, each robotic picker may be capable of picking and/or sorting all required classes of objects to be picked and/or sorted, the selected robotic picker assigned to a given object to be picked and/or sorted chosen by the processing system.

The robotic picker may be selected by the processing system according to a number of factors.

The processing system of the robotic system may be configured to receive positional data and/or operational status data relating to each of the robotic pickers. The processing system may interrogate the positional data and/or operational status relating to each of the robotic pickers and determine which of the robotic pickers to assign the selected object to be picked and/or sorted. For example, the processing system may interrogate the positional data and/or operational status relating to each of the robotic pickers and determine which of the robotic pickers is available at the predicted time the object passes the robotic picker arrangement and/or which robotic picker is closest to the object to be picked and/or sorted. The processing system may then assign the selected object to be picked and/or sorted to the selected one of the robotic pickers.

Beneficially, by working collaboratively as a team the robotic pickers facilitate greater efficiency of operation, since the robotic pickers may be selected to reduce redundancy of each robotic picker and/or may be selected to reduce the travel distance to a given object to be picked and/or selected, thereby increasing response time and reducing energy use.

As described above, in the waste processing and recycling sector, human operatives are still currently involved in picking out contaminants, such as tapes, wires, nappies and plastic bags, and in verifying that different waste materials have been correctly sorted and, where necessary, carrying out remedial operations. As noted, such manual processes pose a significant health risk to operatives working in the vicinity of the waste processing system, both in terms of proximity to machinery and in terms of potential exposure to hazardous materials.

The robotic system facilitates the efficient picking and/or sorting of such contaminants, thereby eliminating or at least reducing the exposure of personnel to these potentially hazardous materials. The robotic system also facilitates greater efficiency in the identification of objects to be picked, thereby eliminating or at least reducing the need for manual verification. Greater efficiency in the identification of objects to be picked may reduce the presence of contaminants (i.e. objects which should have been picked out) in recyclables which may otherwise reduce their value and/or in some cases mean that they must be re-processed or in some cases render them unsuitable for further processing such that they must be sent to landfill.

As described above, the robotic system comprises a robotic picker arrangement operatively associated with a conveyor arrangement for conveying objects to be sorted, and which comprises a plurality of robotic pickers each configured to pick up a selected one or more of said objects from the conveyor arrangement.

The robotic system may comprise, may be coupled to or operatively associated with the conveyor arrangement.

The conveyor arrangement may comprise one or more conveyors. At least of the conveyors may comprise or take the form of a conveyor belt.

The robotic picker arrangement may comprise any suitable number (greater than two) of the robotic pickers. For example, the system may comprise two robotic pickers, three robotic pickers, four robotic pickers, five robotic pickers, six robotic pickers, seven robotic pickers, eight robotic pickers or more than eight robotic pickers.

Beneficially, since the processing system is configured to operate with a robotic picker arrangement comprising a plurality of robotic pickers, the robotic system can be easily scaled, such that the robotic system is highly flexible in terms of the size and/or type of facility in which the robotic system can be installed and/or employed. For example, the robotic system can be easily adapted in the event a given facility increases in size, without significant modification to the processing system infrastructure. Alternatively, the robotic system can be employed in facilities that were otherwise considered too small or remote to merit the investment needed for automation systems. In the case of waste management and/or recycling facilities, for example, the robotic system may be used in MRFs that were otherwise considered unsuitable for automation systems with the result that waste objects were transported to a more distant centralised facility requiring additional carbon footprint.

One or more of the robotic pickers may comprise or take the form of a floor-mounted robot.

One or more of the robotic pickers may comprise a frame. The robotic picker may be configured so that at least part of the frame extends over, or at least partially over, one or more conveyors of the conveyor arrangement. The robotic picker may be configured so that at least part of the frame extends over, or at least partially over, one conveyor. Alternatively, the robotic picker may be configured so that at least part of the frame extends over, or at least partially over, a plurality of conveyors of the conveyor arrangement.

The frame may comprise one or more ground engaging members. The one or more ground engaging members may comprise or take the form of an upright or substantially upright member, stanchion or the like. The frame may comprise a horizontal or substantially horizontal member. The horizontal or substantially horizontal member may be coupled to one or more of the ground engaging members.

One or more of the robotic pickers may comprise one or more robotic arms. The one or more robotic arms may be mounted on and carried by the frame.

The robotic picker may be configured to move, e.g. translate, the robotic arm relative to the frame. The robotic picker may be configured to move, e.g. translate, the robotic arm horizontally relative to the frame. Alternatively or additionally, the robotic picker may be configured to move, e.g. translate, the robotic arm vertically relative to the frame.

In use, the robotic picker may be configured to translate the robotic arm relative to the frame, so as to position the robotic arm laterally and/or vertically with respect to the conveyor arrangement.

The robotic picker may comprise an actuator arrangement for translating the robotic arm relative to the frame. The actuator arrangement may comprise or take the form of one or more linear actuator. The linear actuator may comprise or take the form of one or more belt driven linear actuator.

The one or more belt driven linear actuators may comprise a belt. The one or more belt driven linear actuators may comprise a first pulley wheel. The one or more belt driven linear actuators may comprise a second pulley wheel. The belt may be disposed on and around the first pulley wheel and the second pulley wheel.

The robotic picker may comprise a rail. The rail may comprise or define a linear slide bearing. The rail may form or form part of the horizontal or substantially horizontal member of the frame. The rail may form part of the actuator arrangement.

The robotic picker may comprise a drive arrangement. The drive arrangement may be coupled to or form part of the actuator arrangement. The drive arrangement may be operable under the control of the processing system.

The drive arrangement may comprise one or more drives. One or more of the drives may comprise or take the form of a motor. In particular embodiments, one or more of the drives may comprise or take the form of a servomotor.

The drive arrangement may comprise one or more drives, e.g. servomotors, configured to move the robotic arm from a first, vertical, position to a second, vertical, position. More particularly, the one or more drives configured to move the robotic arm from the first, vertical, position to the second, vertical, position may move the horizontal or substantially horizontal member relative to the one or more ground-engaging members, so as to move the robotic arm from the first, vertical, position to the second, vertical, position. The one or more drives configured to move the robotic arm from the first, vertical, position to the second, vertical, position may define one or more first drives of the drive arrangement.

The drive arrangement may comprise one or more drives, e.g. servomotors, configured to move the robotic arm from a first, lateral, position to a second, lateral, position. More particularly, the one or more drives configured to move the robotic arm from the first, lateral, position to the second, lateral, position may move the robotic arm relative to the horizontal or substantially horizontal member. The one or more drives configured to move the robotic arm from the first, lateral, position to the second, lateral, position may define one or more second drives of the drive arrangement.

The drive arrangement may be configured to move the robotic arm vertically and/or laterally.

In some instances, the vertical and/or lateral movement may position the robotic arm at the selected location to pick up the object. In other instances, the robotic arm itself may complete the move to the required position to pick up the object.

The drive arrangement may be configured and/or operable to move the robotic arm vertically at a higher speed than when moving the robotic arm laterally.

In use, the drive arrangement may be operable to rapidly move the robotic arm from the first, vertical, position to the second, vertical, position and then move the robotic arm from the first, lateral, position to the second, lateral, position at a lower speed, i.e. a lower speed than the vertical movement.

Beneficially, this allows the system to move the robotic arm rapidly to the required location relative to the conveyor while also providing finer control over the final positioning of the robotic arm in order to accurately pick up the selected object to be picked and/or sorted.

Where the robotic arm itself completes the move to the required position to pick up the object, the drive arrangement may be configured and/or operable to move the robotic arm from the first, lateral, position to the second, lateral, position at a higher speed than the speed of movement of the robotic arm when completing the move to pick up the object.

Beneficially, this allows the system to move the robotic arm rapidly to the required location relative to the conveyor while also providing finer control over the final positioning of the robotic arm in order to accurately pick up the selected object to be picked and/or sorted.

The robotic picker may comprise a coupling arrangement for coupling the robotic arm to the actuator arrangement. The coupling arrangement may comprise or take the form of a carriage configured for coupling on the one hand to the actuator arrangement and on the other hand to the robotic arm. The robotic arm may be removably coupled to the carriage. Beneficially, this permits the robotic arm to be readily removed for repair and/or replaced by an alternative robotic arm.

The carriage may be disposed on the rail.

The robotic arm may comprise a first member. The robotic arm may comprise a second member. The second member may be coupled to and carried by the first member.

The robotic arm may comprise a manipulator. The manipulator may be coupled to and carried by the second member. The manipulator may be configured to pick up the object to be picked and/or sorted. The manipulator may comprise or take the form of a mechanical grasp. The manipulator may comprise or take the form of a vacuum gripper.

As described above, the system may comprise, may be coupled to or operatively associated with a sensor arrangement.

The sensor arrangement may comprise one or sensors configured to obtain the sensor data relating to the objects being conveyed by the conveyor arrangement.

The sensor arrangement may comprise one or more sensors configured to obtain the positional data relating to the object to be picked and/or sorted.

The sensor arrangement may comprise one or more sensors configured to obtain the velocity data relating to the object to be picked and/or sorted.

The sensor arrangement may comprise or take the form of a sensor array.

The sensor arrangement may be configured to obtain visual data relating to the objects on the conveyor.

The sensor arrangement may comprise or take the form of a vision system. The sensor arrangement may comprise a camera. The camera may comprise or take the form of a stereo camera. The camera may comprise or take the form of a 2D camera. The sensor arrangement may comprise a remote sensing device, e.g. LIDAR. The sensor arrangement may comprise an RGB sensor.

In particular embodiments, the sensor arrangement comprises a vision system including one or more camera, one or more remote sensing device, e.g. LIDAR, and one or more RGB sensor and the processing system may employ sensor fusion techniques, e.g. a sensor fusion algorithm.

The sensor arrangement may comprise one or more sensors configured to measure electrical resistance of objects on the conveyor.

The sensor arrangement may comprise one or more sensors configured to measure light refraction of objects on the conveyor.

The sensor arrangement may comprise one or more sensors configured to produce 3d point cloud data relating to objects on the conveyor.

At least part of the sensor arrangement may be disposed at an upstream location relative to the plurality of robotic pickers.

At least part of the sensor arrangement may be disposed on a frame, pole, upright member or the like. In particular embodiments, at least part of the sensor arrangement may be disposed on a frame. The robotic system may be configured so that at least part of the frame extends over, or at least partially over, one or more conveyors of the conveyor arrangement. The robotic system may be configured so that at least part of the frame extends over, or at least partially over, one conveyor. Alternatively, the robotic system may be configured so that at least part of the frame extends over, or at least partially over, a plurality of conveyors of the conveyor arrangement.

The frame may comprise one or more ground engaging members. The one or more ground engaging members may comprise or take the form of an upright or substantially upright member, stanchion or the like. The frame may comprise a horizontal or substantially horizontal member. The horizontal or substantially horizontal member may be coupled to one or more of the ground engaging members. The horizontal or substantially horizontal member may be integrally formed with the one or more of the ground engaging members.

Part of the sensor arrangement may be disposed on the robotic arm. The sensor arrangement may comprise one or more sensors disposed on the robotic arm. The one or more sensors may comprise or take the form of a camera.

Alternatively or additionally, part of the sensor arrangement may be disposed on the frame of the robotic picker. The sensor arrangement may comprise one or more sensors disposed on the frame of the robotic picker. The one or more sensors may comprise or take the form of a camera.

In use, the sensor arrangement disposed on the robotic arm and/or the frame of the robotic picker may be utilised to supplement the data from the sensor arrangement disposed upstream of the robotic picker arrangement, thereby providing a more accurate indication of the position of the robotic picker and/or the object to be picked and/or sorted.

As described above, the processing system receives sensor data relating to the objects being conveyed by the conveyor arrangement from the sensor arrangement, the processing system employing one or more object detection algorithms to the sensor data to determine whether any one of the objects being conveyed by the conveyor arrangement corresponds to a predetermined class of objects to be picked and/or sorted by the robotic system.

Beneficially, the use of one or more object detection algorithms permits the robotic system to identify a wide range of objects, e.g. waste items and/or contaminants lying on the conveyor.

The processing system, or part of the processing system, may implement artificial intelligence. For example, the one or more object detection algorithms may be trained on a labelled training set.

The processing system may employ one or more of: a deep neural network; a deep reinforcement learning algorithm; and an object detection algorithm to process the received data.

Each of the robotic pickers of the robotic picker arrangement may comprise an operating system.

Beneficially, the provision of robotic pickers each have an operating system facilitates distributed computing.

The robotic system may comprise a control system. The control system may comprise or take the form of hardware components configured to operate some or all of the processes of the processing system.

The control system may comprise one or more central processing units (CPU). The control system may comprise one or more graphics processing units (GPU).

The control system may comprise one or more memory unit.

At least one of the CPUs, GPUs and memory units may be cloud-based.

Alternatively or additionally, at least one of the CPUs, GPUs and memory units may be local to the robotic system, that is may be disposed on the robotic system.

The control system may comprise or take the form of one or more Programmable Logic Controller (PLC).

The control system, or part of the control system, may form part of the robotic system.

The control system, or part of the control system, may be coupled to or operatively associated with the robotic system. For example, the control system may be located at one or more remote location. The remote location may comprise or take the form of a control room. Alternatively or additionally, the remote location may comprise or take the form of a mobile device such as tablet, mobile phone or the like. Alternatively or additionally, the remote location may comprise or take the form of a data store, such as an online data store.

The robotic system may comprise a communication arrangement.

The communication arrangement may comprise or take the form of a wireless communication arrangement. The wireless communication arrangement may comprise a radio frequency communication arrangement. The communication arrangement may comprise or take the form of a transmitter or transceiver.

The communication arrangement may comprise or take the form of a wired communication arrangement. The wired communication arrangement may comprise or take the form of an electric wire and/or optical fibre communication arrangement.

The communication arrangement may comprise or take the form of a two-way communication arrangement. The communication arrangement may comprise or take the form of a transceiver.

In use, the processing system may receive information from the sensor arrangement and/or the conveyor arrangement, e.g. a control system of the conveyor arrangement, via the communication arrangement and communicate the one or more command signals to the robotic picker arrangement via the communication arrangement.

The robotic system may comprise one or more human machine interface, The human machine interface may comprise or take the form of one or more work stations. human machine interface may comprise or take the form of one or more graphical user interface. The human machine interface may comprise or take the form of a dashboard. According to a second aspect, there is provided an object picking and/or sorting system comprising one or more of the robotic systems according to the first aspect.

The object picking and/or sorting system may form part of a material recovery facility. Alternatively, the object picking and/or sorting system may take the form of a standalone system.

The object picking and/or sorting system may comprise, may be coupled to or operatively associated with a conveyor arrangement. Where the object picking and/or sorting system forms part of a material recovery facility, the object picking and/or sorting system may be coupled to or operatively associated with a conveyor arrangement of the material recovery facility. The conveyor arrangement may comprise one or more conveyors. At least of the conveyors may comprise or take the form of a conveyor belt.

The object picking and/or sorting system may comprise, may be coupled to or operatively associated with one or more bin, hopper or the like. Where the object picking and/or sorting system forms part of a material recovery facility, the object picking and/or sorting system may be coupled to or operatively associated with a bin, hopper or the like of the material recovery facility. The object picking and/or sorting system may comprise, may be coupled to or operatively associated with a plurality of the bins, hoppers or the like.

In use, the robotic system may be operable to pick up the selected one or more objects and place them in one of the bins, hoppers or the like.

According to a third aspect, there is provided a material recovery facility comprising one or more of the robotic systems according to the first aspect and/or one or more object picking and/or sorting system according to the second aspect.

The material recovery facility may comprise a conveyor arrangement. The conveyor arrangement may comprise one or more conveyors. At least of the conveyors may comprise or take the form of a conveyor belt.

The material recovery facility may comprise one or more bin, hopper or the like. The material recovery facility may comprise a plurality of the bins, hoppers or the like.

In use, the robotic system may be operable to pick up the selected one or more objects and place them in one of the bins, hoppers or the like.

According to a fourth aspect, there is provided a method for picking and/or sorting objects, using the robotic system of the first aspect and/or the object picking and/or sorting system according to the second aspect.

In use, the robotic system is installed relative to a conveyor arrangement such that the robotic picker arrangement of the robotic system is capable of picking up objects from the conveyor arrangement. The processing system of the robotic system receives sensor data relating to the objects being conveyed by the conveyor arrangement from the sensor arrangement. The processing system of the robotic system then employs one or more object detection algorithms to the sensor data to determine whether any one of the objects being conveyed by the conveyor arrangement corresponds to a predetermined class of objects to be picked and/or sorted by the robotic system. The processing system also receives positional data relating to the object to be picked and/or sorted from the sensor arrangement and velocity data relating to the object to be picked and/or sorted from the sensor arrangement and/or the conveyor arrangement, which is processed by the processing system to determine the predicted position of the object to be picked and/or sorted as it passes the robotic picker arrangement. The processing system then outputs one or more command signals to the robotic picker arrangement to position one of said robotic pickers relative to the conveyor arrangement to permit said robotic picker to pick up the selected object to be picked and/or sorted from the conveyor arrangement.

According to a fifth aspect, there is provided a robotic picker for picking and/or sorting objects from a conveyor arrangement, the robotic picker comprising:
a frame comprising:
   one or more ground engaging members; and
   a horizontal or substantially horizontal member configured to extend over, or at least partially over, one or more conveyors of the conveyor arrangement;
a robotic arm mounted on and carried by the frame; and
an actuator arrangement for translating the robotic arm relative to the frame, wherein the actuator arrangement comprises or takes the form of one or more belt driven linear actuator.

According to a sixth aspect, there is provided a robotic system for picking and/or sorting objects comprising one or more of the robotic pickers of the fifth aspect.

According to a seventh aspect, there is provided an object picking and/or sorting system comprising one or more of the robotic systems according to the sixth aspect.

According to an eighth aspect, there is provided a material recovery facility comprising one or more of the robotic systems according to the sixth aspect and/or one or more object picking and/or sorting system according to the seventh aspect.

According to a ninth aspect, there is provided a method for picking and/or sorting objects, using the robotic picker of the fifth aspect.

According to another aspect, there is provided a processing system configured to implement one or more of the previous aspects.

The processing system may comprise at least one processor. The processing system may comprise and/or be configured to access at least one data store or memory. The data store or memory may comprise or be configured to receive operating instructions or a program specifying operations of the at least one processor. The at least one processor may be configured to process and implement the operating instructions or program.

The at least one data store may comprise, and/or comprise a reader, drive or other means configured to access, optical storage or disk such as a CD or DVD, flash drive, SD device, one or more memory chips such as DRAMs, a network attached drive (NAD), cloud storage, magnetic storage such as tape or magnetic disk or a hard-drive, and/or the like.

The processing system may comprise a network or interface module. The network or interface module may be connected or connectable to a network connection or data carrier, which may comprise a wired or wireless network connection or data carrier, such as a data cable, powerline data carrier, Wi-Fi, Bluetooth, Zigbee, internet connection or other similar connection. The network interface may comprise a router, modem, gateway and/or the like. The system or processing system may be configured to transmit or otherwise provide the audio signal via the network or interface module, for example over the internet, intranet, network or cloud.

The processing system may comprise a processing apparatus or a plurality of processing apparatus. Each processing apparatus may comprise at least a processor and optionally a memory or data store and/or a network or interface module. The plurality of processing apparatus may communicate via respective network or interface modules. The plurality of processing apparatus may form, comprise or be comprised in a distributed or server/client based processing system.

According to another aspect, there is provided a computer program product configured such that when processed by a suitable processing system configures the processing system to implement one or more of the previous aspects.

The computer program product may be provided on or comprised in a carrier medium. The carrier medium may be transient or non-transient. The carrier medium may be tangible or non-tangible. The carrier medium may comprise a signal such as an electromagnetic or electronic signal. The carrier medium may comprise a physical medium, such as a disk, a memory card, a memory, and/or the like.

According to another aspect, there is provided a carrier medium, the carrier medium comprising a signal, the signal when processed by a suitable processing system causes the processing system to implement one or more of the previous aspects.

It will be well understood by persons of ordinary skill in the art that whilst some embodiments may implement certain functionality by means of a computer program having computer-readable instructions that are executable to perform the method of the embodiments. The computer program functionality could be implemented in hardware (for example by means of a CPU or by one or more ASICs (application specific integrated circuits)) or by a mix of hardware and software.

Whilst particular pieces of apparatus have been described herein, in alternative embodiments, functionality of one or more of those pieces of apparatus can be provided by a single unit, processing resource or other component, or functionality provided by a single unit can be provided by two or more units or other components in combination. For example, one or more functions of the processing system may be performed by a single processing device, such as a personal computer or the like, or one or more or each function may be performed in a distributed manner by a plurality of processing devices, which may be locally connected or remotely distributed.

The invention is defined by the appended claims. However, for the purposes of the present disclosure it will be understood that any of the features defined above or described below may be utilised in isolation or in combination. For example, features described above in relation to one of the above aspects or below in relation to the detailed description below may be utilised in any other aspect, or together form a new aspect.

### BRIEF DESCRIPTION OF THE DRAWINGS

These and other aspects will now be described by way of example with reference to the accompanying drawings, of which:

FIG. 1 shows a perspective view of a robotic system for picking and/or sorting objects according to the present disclosure;

FIG. 2 shows a diagrammatic view of the system topology of the robotic system shown in FIG. 1;

FIG. 3 shows a first robotic picker of the system shown in FIG. 1;

FIG. 4 shows an enlarged view of a robotic arm of the first robotic picker shown in FIG. 3;

FIG. 5 shows a second robotic picker of the system shown in FIG. 1;

FIG. 6 shows an enlarged view of a robotic arm of the second robotic picker shown in FIG. 5;

FIG. 7 shows an enlarged view of the sensor arrangement of the robotic system;

FIG. 8 shows a perspective view of an alternative robotic system for picking and/or sorting objects according to the present disclosure;

FIG. 9 shows a perspective view of an alternative robotic system for picking and/or sorting objects;

FIG. 10 shows a perspective view of part of a robotic picker of the robotic system shown in FIG. 9;

FIG. 11 shows a diagrammatic view of the system topology of the robotic system shown in FIG. 9;

FIG. 12 shows an object picking and/or sorting system according to the present disclosure;

FIG. 13 shows a Material Recovery Facility comprising robotic systems according to the present disclosure; and

FIG. 14 shows a perspective view of an alternative robotic system for picking and/or sorting objects.

### DETAILED DESCRIPTION OF THE DRAWINGS

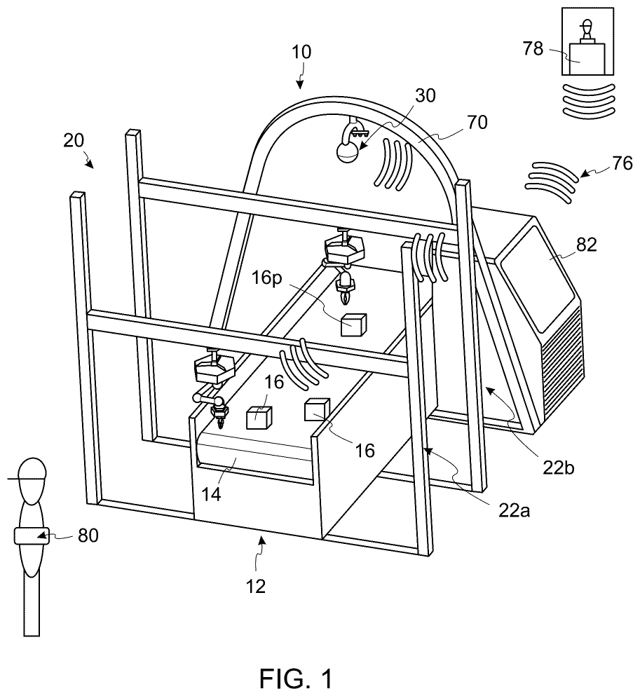

Referring first to FIG. 1 of the accompanying drawings, there is shown a robotic system, generally denoted 10, for picking and/or sorting objects 16.

As shown, the robotic system 10 is operatively associated with a conveyor arrangement, generally denoted 12, comprising a conveyor 14 for conveying the objects 16, which as shown in FIG. 1 includes objects 16p, e.g. waste items and/or recyclables, which are desired to be picked and/or sorted. The illustrated conveyor 14 takes the form of a belt conveyor. However, it will be recognised that the robotic system 10 may be operable with a range of conveyor types.

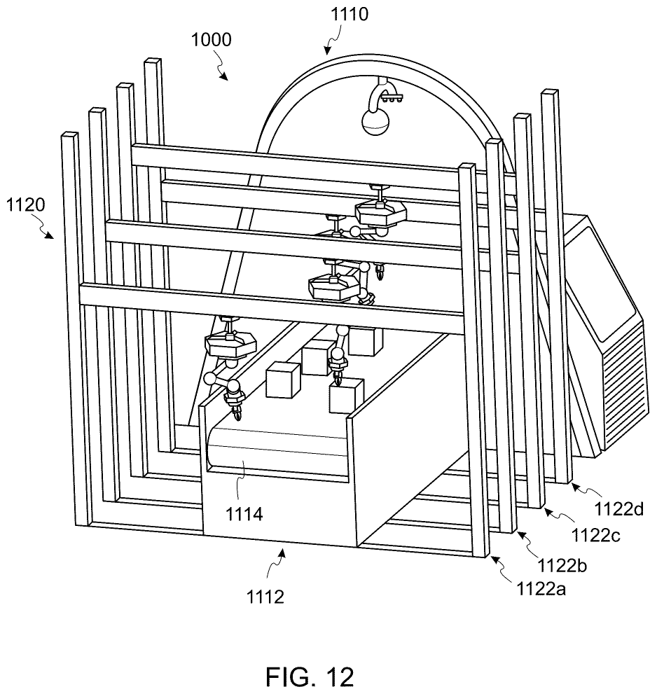

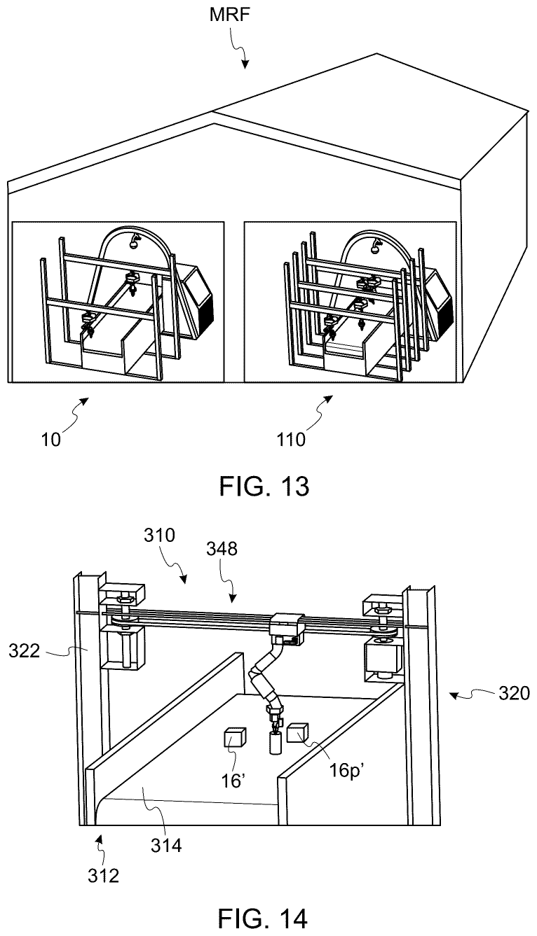

The conveyor arrangement 12 shown in FIG. 1 forms part of a materials recovery facility MRF (see FIG. 13). However, it will be understood that an alternative robotic system according to the present disclosure may comprise or may be provided in combination with a conveyor to form or form part of a standalone object picking and/or sorting system 1000 (see FIG. 12).

In use, the robotic system 10 is operable to pick up the selected objects 16p from the conveyor 14 and deposit them in a selected bin or hopper (not shown).

As shown in FIG. 1, the robotic system 10 comprises a collaborative robotic picker arrangement, generally denoted 20, comprising a plurality of robotic pickers 22a, 22b each configured to pick up one or more of the objects 16p from the conveyor 14.

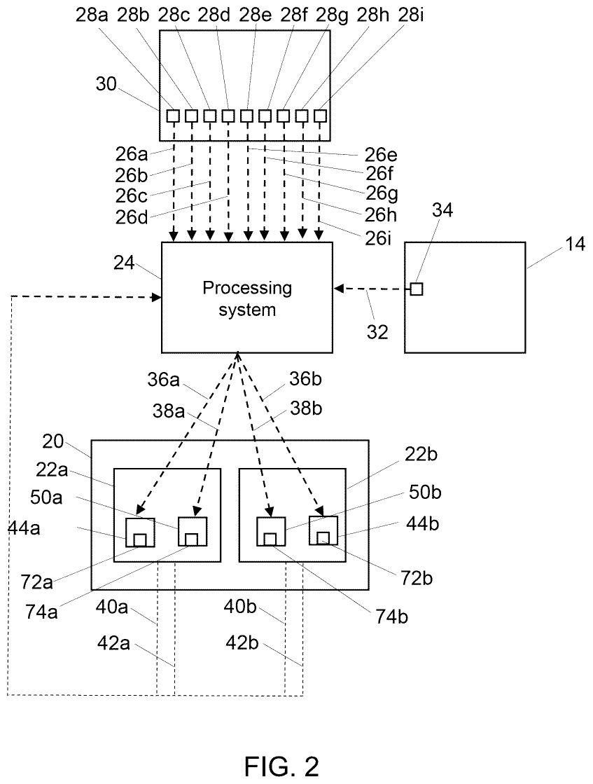

Referring now also to FIG. 2 of the accompanying drawings, the robotic system 10 further comprises a processing system 24. The processing system 24 is configured to receive sensor data 26a, 26b, 26c relating to the objects 16 being conveyed from sensors 28a, 28b, 28c of a sensor arrangement 30 forming part of, coupled to or operatively associated with the robotic system 10. The processing system 24 is configured to interrogate the received sensor data 26a, 26b, 26c using one or more object detection algorithms to determine, from the received sensor data 26a, 26b, 26c, whether any one of the objects 16 being conveyed corresponds to a predetermined class of objects 16p to be picked and/or sorted by the robotic system 10.

The processing system 24 is also configured to receive positional data 26d, 26e, 26f relating to the object(s) 16p to be picked and/or sorted from sensors 28d, 28e, 28f of the sensor arrangement 30 and velocity data 26g, 26h, 26i relating to the object(s) 16p to be picked and/or sorted from sensors 28g, 28h, 28i of the sensor arrangement 30.

In the illustrated robotic system 10, the processing system 24 is also configured to receive velocity data 32 relating to the object(s) 16p to be picked and/or sorted from one or more sensors 34 of the conveyor 14.

The processing system 24 is configured to interrogate said received positional data 26d, 26e, 26f and velocity data 26g, 26h, 26i to determine a predicted position of the object(s) 16p to be picked and/or sorted as it passes the robotic picker arrangement 20.

The processing system 24 is configured to output one or more command signals 36a, 36b, 38a, 38b to the robotic picker arrangement 20 to position one of said robotic pickers 22a; 22b relative to the conveyor 14 to permit the robotic picker 22a; 22b to pick up the selected object(s) 16p to be picked and/or sorted from the conveyor 14.

In use, the robotic system 10 is installed relative to the conveyor 14 such that the robotic picker arrangement 20 of the robotic system 10 is capable of picking up the objects 16p from the conveyor 14. The processing system 24 of the robotic system 10 receives the sensor data 26a, 26b, 26c relating to the objects 16 being conveyed by the conveyor 14 and employs one or more object detection algorithms to the sensor data 26a, 26b, 26c to determine whether any one of the objects 16 being conveyed by the conveyor 14 corresponds to the predetermined class of objects 16p to be picked and/or sorted by the robotic system 10. The processing system 24 also receives the positional data 26d, 26e, 26f relating to the object 16p to be picked and/or sorted and the velocity data 26g, 26h, 26i, 32 relating to the object 16p to be picked and/or sorted, which is processed by the processing system 24 to determine the predicted position of the object 16p to be picked and/or sorted as it passes the robotic picker arrangement 20. The processing system 24 then outputs the one or more command signals 36a, 36b, 38a, 38b to the robotic picker arrangement 20 to position one of said robotic pickers 22a; 22b relative to the conveyor 14 to permit said robotic picker 22a; 22b to pick up the selected object 16p to be picked and/or sorted from the conveyor 14 and to convey said object 16p to the bin or hopper (not shown).

The robotic system 10 provides a number of significant benefits compared to conventional systems and techniques for picking and/or sorting objects 16. For example, since the processing system 24 of the robotic system 10 provides command signals 36a, 36b, 38a, 38b to a plurality of robotic pickers 22a, 22b, the robotic system 10 is capable to operating the robotic pickers 22a, 22b collaboratively. This facilitates a greater capacity in terms of the volume of objects 16p that can be picked and/or sorted and/or a greater capacity in terms of the types of objects 16p that can be picked and/or sorted at one time.

The provision of a collaborative robotic picker arrangement 20 means that each of the robotic pickers 22a, 22b can be assigned a plurality of classes of objects 16p to be picked and/or sorted. In the illustrated robotic system 10, each robotic picker 22a, 22b is capable of picking and/or sorting all required classes of objects 16p to be picked and/or sorted, the selected robotic picker 22a; 22b assigned to a given object 16p to be picked and/or sorted chosen by the processing system 24.

The robotic picker 22a; 22b may be selected by the processing system 24 according to a number of factors. The processing system 24 may be configured to receive positional data 40a, 40b and/or operational status data 42a, 42b relating to each of the robotic pickers 22a, 22b. The processing system may interrogate the positional data 40a, 40b and/or operational status data 42a, 42b relating to each of the robotic pickers 22a, 22b and determine which of the robotic pickers 22a, 22b to assign the selected object 16p to be picked and/or sorted.

Beneficially, by working collaboratively as a team the robotic pickers 22a, 22b facilitate greater efficiency of operation, since the robotic pickers 22a, 22b may be selected to reduce redundancy of each robotic picker 22a, 22b and/or may be selected to reduce the travel distance to a given object 16p to be picked and/or selected, thereby increasing response time and reducing energy use.

As described above, in the waste processing and recycling sector, human operatives are still currently involved in picking out contaminants, such as tapes, wires, nappies and plastic bags, and in verifying that different waste materials have been correctly sorted and, where necessary, carrying out remedial operations. As noted, such manual processes pose a significant health risk to operatives working in the vicinity of the waste processing system, both in terms of proximity to machinery and in terms of potential exposure to hazardous materials.

The robotic system 10 facilitates the efficient picking and/or sorting of such contaminants, thereby eliminating or at least reducing the exposure of personnel to these potentially hazardous materials. The robotic system 10 also facilitates greater efficiency in the identification of objects 16p to be picked, thereby eliminating or at least reducing the need for manual verification. Greater efficiency in the identification of objects 16p to be picked may reduce the presence of contaminants (i.e. objects 16p which should have been picked out) in recyclables which may otherwise reduce their value and/or in some cases mean that they must be re-processed or in some cases render them unsuitable for further processing such that they must be sent to landfill.

As described above, the robotic system 10 comprises a robotic picker arrangement 20 operatively associated with the conveyor 14 for conveying objects 16 to be sorted, and which comprises a plurality of robotic pickers 22a,22b each configured to pick up a selected one or more of said objects 16p from the conveyor 14.

In the illustrated robotic apparatus 10, the apparatus 10 comprises two robotic pickers 22a, 22b. However, it will be understood that the robotic apparatus 10 may comprise any suitable number (greater than two) of the robotic pickers 22a, 22b.

Beneficially, since the processing system 24 is configured to operate with a robotic picker arrangement 20 comprising a plurality of robotic pickers 22a, 22b, the robotic system 10 can be easily scaled, such that the robotic system 10 is highly flexible in terms of the size and/or type of facility in which the robotic system 10 can be installed and/or employed. For example, the robotic system 10 can be easily adapted in the event a given facility increases in size, without significant modification to the processing system infrastructure. Alternatively, the robotic system 10 can be employed in facilities that were otherwise considered too small or remote to merit the investment needed for automation systems. In the case of waste management and/or recycling facilities, for example, the robotic system 10 may be used in MRFs that were otherwise considered unsuitable for automation systems with the result that waste objects were transported to a more distant centralised facility requiring additional carbon footprint.

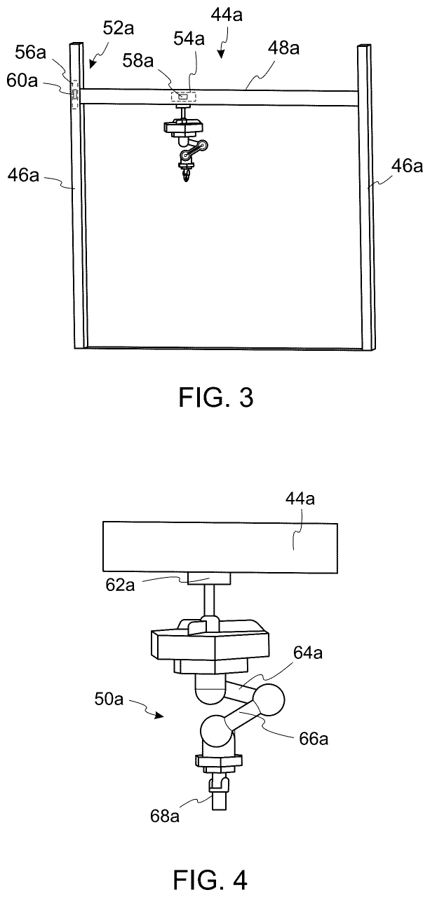

FIGS. 3 and 4 of the accompanying drawings show the robotic picker 22a.

As shown in FIG. 3, the robotic picker 22a takes the form of a floor-mounted robot. The robotic picker 22a comprises a frame 44a that extends over the conveyor 14. The frame 44a comprises one or more ground engaging members 46a that take the form of an upright stanchions and a horizontal member 48a. The horizontal member 48a is coupled to and movable relative to the ground engaging members 46a.

As shown in FIG. 3, the robotic picker 22a further comprises a robotic arm 50a mounted on and carried by the frame 44a.

In use, the robotic picker 22a is configured to translate the robotic arm 50a horizontally and vertically relative to the frame 44a, so as to position the robotic arm 50a laterally and vertically with respect to the conveyor 14.

The robotic picker 22a comprises an actuator arrangement, generally denoted 52a, for translating the robotic arm 50a relative to the frame 44a. In the illustrated robotic system 10, the actuator arrangement 52a comprises belt driven linear actuators 54a, 56a operable by servomotors 58a, 60a. The actuator 54a is configured to translate the robotic arm 50a horizontally/laterally with respect to the frame 44a. The actuator 56a is configured to translate the robotic arm 50a vertically with respect to the frame 44a. It will be recognised that while the robotic system 10 comprises actuators 54a, 56a for translating the robotic arm 50a horizontally and vertically, in alternative robotic systems according to the present disclosure the robotic system may comprise an actuator for translating the robotic arm horizontally only. In such embodiments, the robotic arm may perform all of the required vertical movement to pick up the selected object.

In use, the robotic system 10 is operable to rapidly move the robotic arm 50a from a first position relative to the frame 44a to a second position relative to the frame 44a and then complete the move to the required position to pick up the object 16p.

As shown in FIG. 4, the robotic picker 22a comprises a coupling arrangement 62a for coupling the robotic arm 50a to the actuator 54a. In the illustrated robotic system 10, the coupling arrangement 62a takes the form of a carriage configured for coupling on the one hand to the actuator 54a and on the other hand to the robotic arm 50a. In the illustrated robotic system 10, the robotic arm 50a is removably coupled to the coupling arrangement 62a. Beneficially, this permits the robotic arm 50a to be readily removed for repair and/or replaced by an alternative robotic arm.

As shown in FIG. 4, the robotic arm 50a of the robotic picker 22a takes the form of a 6-axis robot comprising a first member 64a rotatably coupled at a proximal end to the frame 44a via the coupling arrangement 62a and at a distal end to a second member 66a.

The robotic arm 50a further comprises a manipulator 68a. The manipulator 68a is coupled to and carried by the second member 66a. In the illustrated robotic apparatus 10, the manipulator 68a takes the form of a vacuum gripper configured to pick up the object 16p to be picked and/or sorted.

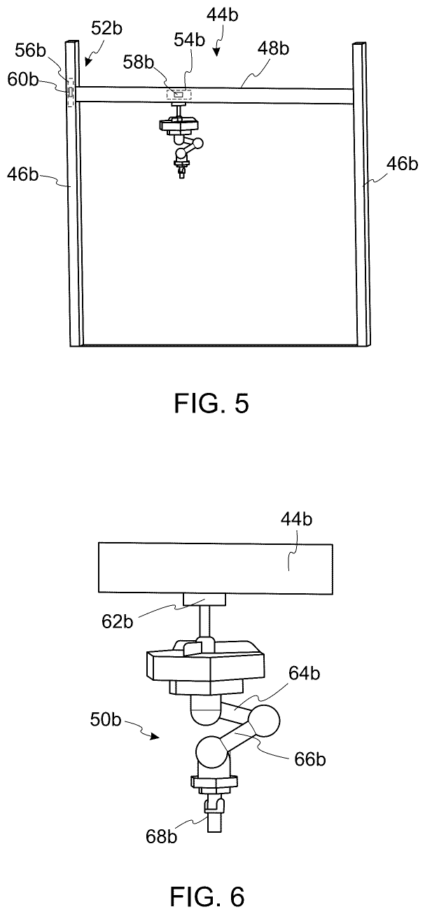

FIGS. 5 and 6 of the Accompanying Drawings Show the Robotic Picker 22b.

As shown in FIG. 5, the robotic picker 22b takes the form of a floor-mounted robot. The robotic picker 22b comprises a frame 44b that extends over the conveyor 14. The frame 44b comprises one or more ground engaging members 46b that take the form of an upright stanchions and a horizontal member 48b. The horizontal member is coupled to and movable relative to the ground engaging members 46b.

As shown in FIG. 5, the robotic picker 22b further comprises a robotic arm 50b mounted on and carried by the frame 44b.

In use, the robotic picker 22b is configured to translate the robotic arm 50b horizontally and vertically relative to the frame 44b, so as to position the robotic arm 50b laterally and vertically with respect to the conveyor 14.

The robotic picker 22b comprises an actuator arrangement, generally denoted 52b, for translating the robotic arm 50b relative to the frame 44b. In the illustrated robotic system 10, the actuator arrangement 52b comprises belt driven linear actuators 54b, 56b operable by servomotors 58b, 60b. The actuator 54b is configured to translate the robotic arm 50b horizontally/laterally with respect to the frame 44b. The actuator 56b is configured to translate the robotic arm 50b vertically with respect to the frame 44b.

In use, the robotic system 10 is operable to rapidly move the robotic arm 50b from a first position relative to the frame 44b to a second position relative to the frame 44b and then complete the move to the required position to pick up the object 16p.

As shown in FIG. 6, the robotic picker 22b comprises a coupling arrangement 62b for coupling the robotic arm 50b to the actuator 54b. In the illustrated robotic system 10, the coupling arrangement 62b takes the form of a carriage configured for coupling on the one hand to the actuator 54b and on the other hand to the robotic arm 50b. In the illustrated robotic system 10, the robotic arm 50b is removably coupled to the coupling arrangement 62b. Beneficially, this permits the robotic arm 50b to be readily removed for repair and/or replaced by an alternative robotic arm.

As shown in FIG. 6, the robotic arm 50b of the robotic picker 22b takes the form of a 6-axis robot comprising a first member 64b rotatably coupled at a proximal end to the frame 44b via the coupling arrangement 62b and at a distal end to a second member 66b.

The robotic arm 50b further comprises a manipulator 68b. The manipulator 68b is coupled to and carried by the second member 66b. In the illustrated robotic apparatus 10, the manipulator 68b takes the form of a mechanic gripper configured to pick up the object 16p to be picked and/or sorted.

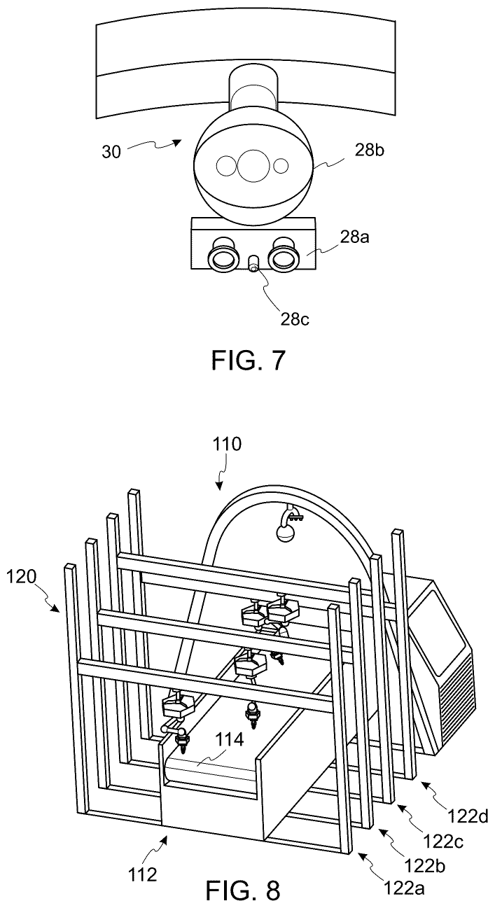

Referring again to FIGS. 1 and 2, and referring now also to FIG. 7 of the accompanying drawings, the sensor arrangement 30 of the illustrated robotic system 10 comprises a vision system disposed on a frame 70 upstream of the robotic picker arrangement 20, the sensor 28a taking the form of a 2D camera, the sensor 28b taking the form of a remote sensing device, e.g. a LIDAR, and the sensor 28c taking the form of an RGB sensor. In use, the processing system 24 employs sensor fusion techniques, e.g. a sensor fusion algorithm.

As shown in FIG. 2, the sensor arrangement 30 further comprises a sensor 72a in the form of camera disposed on the robotic arm 50a and a sensor 72b in the form of camera disposed on the robotic arm 50b. The sensor arrangement 30 of the illustrated robotic system 10 further comprises a sensor 74a in the form of a camera disposed on the frame 44a and a sensor 74b in the form of a camera disposed on the frame 44b.

In use, the sensors 72a, 72b, 74a, 74b are utilised to supplement the data from the sensors disposed upstream of the robotic picker arrangement 20, thereby providing a more accurate indication of the position of the robotic pickers 22a,22b and/or the object 16p to be picked and/or sorted.

As described above, the processing system 24 receives sensor data relating to the objects 16 being conveyed by the conveyor 14 from the sensor arrangement 30, the processing system 24 employing one or more object detection algorithms to the sensor data to determine whether any one of the objects 16 being conveyed by the conveyor 14 corresponds to a predetermined class of objects 16p to be picked and/or sorted by the robotic system 10.

Beneficially, the use of one or more object detection algorithms permits the robotic system 10 to identify a wide range of objects 16p, e.g. waste items and/or contaminants lying on the conveyor 14.

The processing system 24 implements artificial intelligence, the processing system 24 employing one or more of: a deep neural network; a deep reinforcement learning algorithm; and an object detection algorithm to process the received data.

As shown in FIG. 1, the robotic system 10 comprises a communication arrangement, generally denoted 76. In the illustrated robotic system 10, the communication arrangement comprises a wireless communication arrangement in the form of a two way radio frequency communication arrangement. However, it will be recognised that the communication arrangement may alternatively or additionally comprise or take the form of a wired communication arrangement such as an electric wire and/or optical fibre communication arrangement and/or a one-way communication arrangement.

In use, the processing system 24 receives information from the sensor arrangement 30 and/or the conveyor 12 via the communication arrangement 76 and communicate the one or more command signals to the robotic picker arrangement 20 via the communication arrangement 76.

The communication arrangement 76 may also be utilised to communicate information to a remote location. In the illustrated robotic system 10, the remote location takes the form of a control room 78 and/or a mobile device 80.

The robotic system 10 further comprises a human machine interface in the form of a work station 82.

Various modifications may be made without departing from the scope of the invention as defined in the claims.

For example, FIG. 8 of the accompanying drawings shows an alternative robotic system 110. The robotic apparatus 110 is similar to the system 10. As noted above, the robotic apparatus is readily scalable, the robotic apparatus 110 comprising a collaborative robotic picker arrangement 120 comprising four robotic pickers 122a, 122b, 122c, 122d operatively associated with conveyor 114 of conveyor arrangement 112 rather than two robotic pickers 22a, 22b as in the robotic system 10.

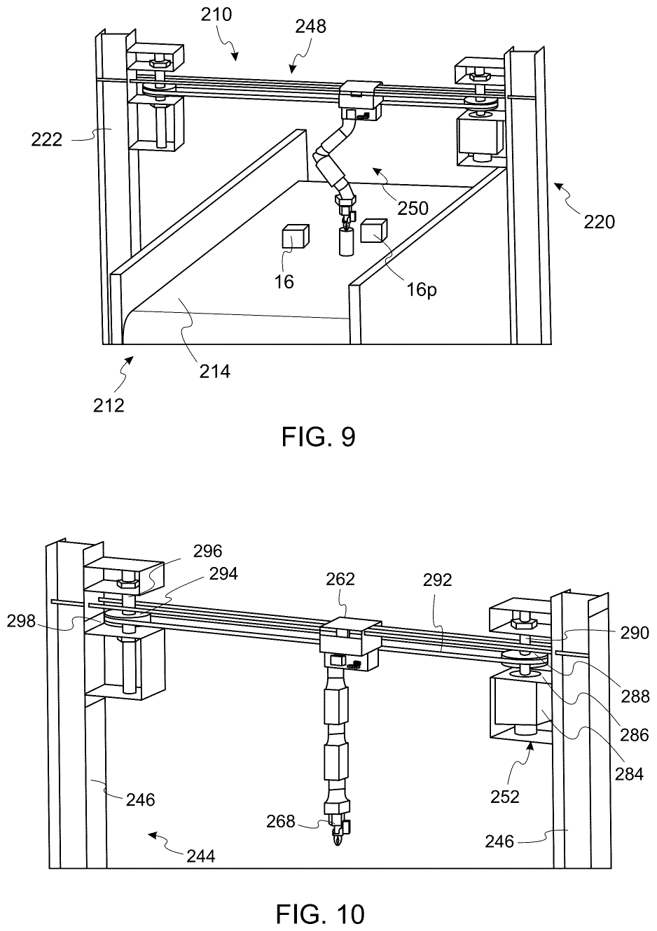

FIGS. 9, 10 and 11 of the accompanying drawings show an alternative robotic system 210 for picking and/or sorting objects 16.

As shown, the robotic system 210 is operatively associated with a conveyor arrangement, generally denoted 212, comprising a conveyor 214 for conveying the objects 16, which as shown in FIG. 9 includes an object 16p, e.g. a waste item and/or recyclable, to be picked and/or sorted. The illustrated conveyor 214 takes the form of a belt conveyor. However, it will be recognised that the robotic system 210 may be operable with a range of conveyor types.

In use, the robotic system 210 is operable to pick up the selected object 16p from the conveyor 214 and deposit it in a selected bin or hopper (not shown).

The robotic system 210 comprises a collaborative robotic picker arrangement, generally denoted 220, comprising a plurality of robotic pickers 222 (for clarity and ease of reference only one of the robotic pickers 222 is shown).

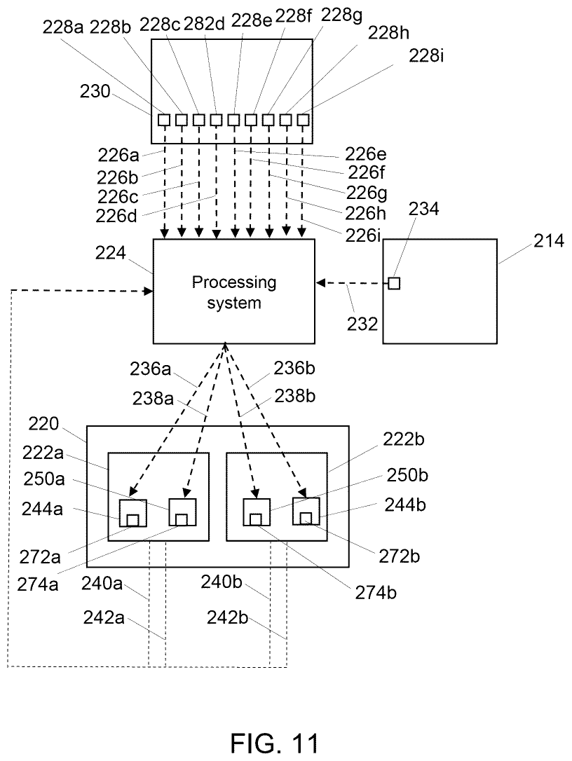

As shown in FIG. 11, the robotic system 210 further comprises a processing system 224. The processing system 224 is similar to the processing system 24 described above. The processing system 224 is configured to receive sensor data 226a, 226b, 226c relating to the objects 16 being conveyed from sensors 228a, 228b, 228c of a sensor arrangement 230 forming part of, coupled to or operatively associated with the robotic system 210. The processing system 224 is configured to interrogate the received sensor data 226a, 226b, 226c using one or more object detection algorithms to determine, from the received sensor data 226a, 226b, 226c, whether any one of the objects 16 being conveyed corresponds to a predetermined class of the objects 16p to be picked and/or sorted by the robotic system 210.

The processing system 224 is also configured to receive positional data 226d, 226e, 226f relating to the object(s) 16p to be picked and/or sorted from sensors 228d, 228e, 228f of the sensor arrangement 230 and velocity data 226g, 226h, 226i relating to the object(s) 16p to be picked and/or sorted from sensors 228g, 228h, 228i of the sensor arrangement 230.

In the illustrated robotic system 210, the processing system 224 is also configured to receive velocity data 232 relating to the object(s) 16p to be picked and/or sorted from one or more sensors 234 of the conveyor 214.

The processing system 224 is configured to interrogate said received positional data 226d, 226e, 226f and velocity data 226g, 226h, 226i to determine a predicted position of the object(s) 16p to be picked and/or sorted as it passes the robotic picker arrangement 220.

The processing system 224 is configured to output one or more command signals 236a, 236b, 238a, 238b to the robotic picker arrangement 220 to position one of said robotic pickers 222 relative to the conveyor 214 to permit the selected robotic picker 222 to pick up the selected object(s) 16p to be picked and/or sorted from the conveyor 214.

In use, the robotic system 210 is installed relative to the conveyor 214 such that the robotic picker arrangement 220 of the robotic system 210 is capable of picking up the objects 16 from the conveyor 214. The processing system 224 of the robotic system 210 receives the sensor data 226a, 226b, 226c relating to the objects 16 being conveyed by the conveyor 214 and employs one or more object detection algorithms to the sensor data 226a, 226b, 226c to determine whether any one of the objects 16 being conveyed by the conveyor 214 corresponds to the predetermined class of objects 16p to be picked and/or sorted by the robotic system 210. The processing system 224 also receives the positional data 226d, 226e, 226f relating to the object 16p to be picked and/or sorted and the velocity data 226g, 226h, 226i, 232 relating to the object 16p to be picked and/or sorted, which is processed by the processing system 224 to determine the predicted position of the object 16p to be picked and/or sorted as it passes the robotic picker arrangement 220. The processing system 224 then outputs the one or more command signals 236a, 236b, 238a, 238b to the robotic picker arrangement 220 to position one of said robotic pickers 222 relative to the conveyor 214 to permit said robotic picker 222 to pick up the selected object 16p to be picked and/or sorted from the conveyor 214 and to convey said object 16p to the bin or hopper (not shown).

As shown in FIGS. 9 and 10, the robotic picker 222 takes the form of a floor-mounted robot. The robotic picker 222 comprises a frame 244 that extends over the conveyor 214. The frame 244 comprises ground engaging members 246 that take the form of upright stanchions and a horizontal member 248. The horizontal member 248 is coupled to and movable relative to the ground engaging members 246.

The robotic picker 222 further comprises a robotic arm 250 mounted on and carried by the frame 244.

In use, the robotic picker 222 is configured to translate the robotic arm 250 horizontally, so as to position the robotic arm 250 laterally with respect to the conveyor 214

The robotic picker 222 further comprises an actuator arrangement, generally denoted 252, for translating the robotic arm 250 relative to the frame 244. In the illustrated robotic system 210, the actuator arrangement 252 comprises or takes the form of a belt driven linear actuator.

As shown, the robotic picker 222 comprises a rotary drive 284, which in the illustrated system 210 takes the form of a motor. The rotary drive 284 is coupled to one of the ground engaging members 246 via a bracket 286. A first pulley wheel 288, which in operation defines a drive pulley of the actuator arrangement 252, is disposed on drive shaft 290 of the rotary drive 284, such that the first pulley wheel 288 is driven by the rotary drive 284.

A belt 292 is disposed around the first pulley wheel 288 and extends around a second pulley wheel 294, which in operation defines a driven pulley of the actuator arrangement 252. As shown, the second pulley wheel 294 is rotatably mounted to the other ground engaging member 246 via shaft 296 and bracket 298.

In the illustrated system, the horizontal member 248 comprises or takes the form of a rail which extends between the ground engaging members 246.

The robotic picker 222 comprises a coupling arrangement 262 for coupling the robotic arm 250 to the actuator arrangement 252. In the illustrated robotic system 210, the coupling arrangement 262 takes the form of a carriage slidably mounted to the horizontal member 248. The coupling arrangement 262 engages with and is configured to be driven by the belt 292.

As shown in FIGS. 9 and 10, the robotic arm 250 of the robotic picker 222 takes the form of a 6-axis robot and comprises a manipulator 268. In the illustrated robotic apparatus 210, the manipulator 268 takes the form of a gripper configured to pick up the object 16p to be picked and/or sorted.

In use, the rotary drive 284 and actuator arrangement 252 are operable to move the robotic arm 250 from a first, lateral, position to a second, lateral, position. Having moved the robotic arm 250 from the first position to the second position, the robotic arm 250 itself then completes the move to the required position to pick up the object 16p.

Beneficially, the system 210 is configured and/or operable to rapidly move the robotic arm 250 from the first position to the second position, with the robotic arm 250 providing a slower, more accurate, movement as the robotic arm 250 comes into proximity to the object 16p to be picked and/or sorted.

FIG. 12 of the accompanying drawings shows an object picking and/or sorting system 1000. As described above, whereas the robotic system 10 described above is operatively associated with a conveyor arrangement 12 comprising a conveyor 14, the object picking and/or sorting system 1000 comprises robotic system 1110 and a conveyor arrangement 1112 comprising a conveyor 1114. The robotic system 1110 corresponds to the robotic system 110 and comprises a robotic picker arrangement 1120 comprising four robotic pickers 1122a, 1122b, 1122c, 1122d. However, it will be understood that the robotic system 1110 may alternatively comprise or take the form of the robotic system 10.

Beneficially, the object picking and/or sorting system 1000 may provide a standalone system for picking and/or sorting objects 16.

As described above, the robotic systems 10, 110 are particularly beneficial for use in picking objects 16p in a material recovery facility (MRF). FIG. 13 of the accompanying drawings shows a material recovery facility MRF comprising a plurality of the robotic systems, more specifically one of the two agent robotic systems 10 and one of the four agent robotic systems 110. However, it will be understood that the material recovery facility MRF may comprise one of the robotic systems 10 or 110, one or more of the object picking and/or systems 1000, or any combination of the robotic systems 10,110 and object picking and/or sorting systems 1000.

It will be understood that the robotic systems described herein may be configured and/or operable to pick and/or sort objects in a variety of sectors, including for example but not exclusively the construction sector, the e-waste sector and/or the textile sector. In the construction sector, for example, the robotic system may be configured and/or operable to pick and/or sort objects such as: waste wood; tarpaulins; metal bars; metal box sections; and/or rubble. In the e-waste sector, for example, the robotic system may be configured and/or operable to pick and/or sort objects such as: printed circuit boards; valves; wires; and/or electrical components such as capacitors, resistors, diodes, etc. In the textile sector, for example, the robotic system may be configured and/or operable to pick and/or sort objects such as: cotton materials; nylon materials; synthetic fabric materials; hemp materials, uniforms; and/or accessories such as belts.

By way of example, FIG. 14 of the accompanying drawings shows a robotic system, generally denoted 310, for picking and/or sorting objects 16′.

As shown, the robotic system 310 is operatively associated with a conveyor arrangement, generally denoted 312, comprising a conveyor 314 for conveying the objects 16′, which as shown in FIG. 14 include an object 16p′ in the form of an item of construction waste to be picked and/or sorted.

In use, the robotic system 310 is operable to pick up the selected object 16p′ from the conveyor 314 and deposit it in a selected bin or hopper (not shown).

The robotic system 310 comprises a collaborative robotic picker arrangement, generally denoted 320, comprising a plurality of robotic pickers 322 (for clarity and ease of reference only one of the robotic pickers 322 is shown). As shown in FIG. 14, the robotic system 310 substantially corresponds to the robotic system 210 described above. However, it will be understood that any of the robotic systems may be employed to pick and/or sort the objects 16′ or other types of objects such as those from the e-waste sector and/or textile sectors.

1. A robotic system for picking and/or sorting objects, the robotic system comprising:
a collaborative robotic picker arrangement operatively associated with a conveyor arrangement for conveying objects to be sorted,
wherein the robotic picker arrangement comprises a plurality of robotic pickers each configured to pick up a selected one or more of said objects from the conveyor arrangement; and
a processing system,
wherein the processing system is configured to receive sensor data relating to the objects being conveyed by the conveyor arrangement from a sensor arrangement forming part of, coupled to or operatively associated with the robotic system,
the processing system configured to interrogate said received sensor data using one or more object detection algorithms to determine from the received sensor data whether any one of the objects being conveyed by the conveyor arrangement corresponds to a predetermined class of objects to be picked and/or sorted by the robotic system,
wherein the processing system is configured to receive positional data relating to the object to be picked and/or sorted from the sensor arrangement and velocity data relating to the object to be picked and/or sorted from the sensor arrangement and/or the conveyor arrangement,
the processing system configured to interrogate said received positional and velocity data to determine a predicted position of the object to be picked and/or sorted as it passes the robotic picker arrangement, and
wherein the processing system is configured to output one or more command signals to the robotic picker arrangement to position one of said robotic pickers relative to the conveyor arrangement to permit said robotic picker to pick up the selected object to be picked and/or sorted from the conveyor arrangement.

2. The robotic system of claim 1, wherein the robotic system comprises or takes the form of an integrated robotic picking and/or sorting system.

3. The robotic system of claim wherein the robotic system comprises or takes the form of a distributive robotic picking and/or sorting system.

4. The robotic system of claim 1, wherein the robotic system is modular.

5. The robotic system of claim 1, wherein the processing system of the robotic system is configured to receive positional data and/or operational status data relating to each of the robotic pickers, the processing system configured to interrogate the positional data and/or operational status relating to each of the robotic pickers and determine which of the robotic pickers to assign the selected object to be picked and/or sorted.

6. The robotic system of claim 1, wherein the robotic system comprises, is coupled to or operatively associated with the conveyor arrangement, the conveyor arrangement comprising one or more conveyors.

7. The robotic system of claim 1, wherein one or more of the robotic pickers comprises a frame and one or more robotic arms, the one or more robotic arms mounted on and carried by the frame.

8. The robotic system of claim 7, wherein the robotic picker is configured to move the robotic arm horizontally and/or vertically relative to the frame.

9. The robotic system of claim 8, wherein the robotic picker comprises an actuator arrangement for translating the robotic arm relative to the frame.

10. The robotic system of claim 7, wherein the robotic picker comprises a drive arrangement comprising one or more first drive configured to move the robotic arm from a first position relative to the frame to a second position relative to the frame and one or more second drive configured to move the robotic arm from the second position relative to the frame to a third position relative to the frame.

11. The robotic system of claim 1, wherein the sensor arrangement comprises at least one of:
one or sensors configured to obtain the sensor data relating to the objects being conveyed by the conveyor arrangement;
one or more sensors configured to obtain the positional data relating to the object to be picked and/or sorted; and
one or more sensors configured to obtain the velocity data relating to the object to be picked and/or sorted.

12. The robotic system of claim 1, wherein the sensor arrangement comprises or takes the form of a vision system.

13. The robotic system of claim 1, wherein the sensor arrangement comprises a camera.

14. The robotic system of claim 13, wherein the camera comprises or takes the form of a 2D camera.

15. The robotic system of claim 1, wherein the sensor arrangement comprises a remote sensing device.

16. The robotic system of claim 15, wherein the remote sensing device comprises or takes the form of a LIDAR.

17. The robotic system of claim 1, wherein the sensor arrangement comprises an RGB sensor.

18. The robotic system of claim 1, wherein at least part of the sensor arrangement is disposed on a frame, pole, or upright member.

19. The robotic system of claim 7, wherein the sensor arrangement further comprises one or more sensors disposed on the robotic arm and/or the sensor arrangement comprises one or more sensors disposed on the frame of the robotic picker.

20. The robotic system of claim 1, wherein the processing system, or part of the processing system, implements artificial intelligence, the processing system employing one or more of: a deep neural network; a deep reinforcement learning algorithm; and an object detection algorithm to process the received data.

21. The robotic system of claim 1, wherein each of the robotic pickers of the robotic picker arrangement comprises an operating system.

22. The robotic system of claim 1, comprising a wired or wireless communication arrangement.

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. The robotic system of claim 1 comprised within a object picking and/or sorting system.

50. The robotic system of claim 1 comprised within a material recovery facility.

51. A method for picking and/or sorting objects comprising:
receiving, using a processing system, sensor data relating to the objects being conveyed by a conveyor arrangement from a sensor arrangement forming part of. coupled to or operatively associated with a robotic system,
interrogating, using a processing system, said received sensor data using one or more object detection algorithms to determine from the received sensor data whether any one of the objects being conveyed by a conveyor arrangement corresponds to a predetermined class of objects to be picked and/or sorted by the robotic system,
receiving, using a processing system, positional data relating to the object to be picked and/or sorted from the sensor arrangement and velocity data relating to the object to be picked and/or sorted from the sensor arrangement and/or the conveyor arrangement,
interrogating, using a processing system, said received positional and velocity data to determine a predicted position of the object to be picked and/or sorted as it passes a robotic picker arrangement, wherein the robotic picker arrangement is operatively associated with a conveyor arrangement for conveying objects to be sorted, and wherein the robotic picker arrangement comprises a plurality of robotic pickers each configured to pick up a selected one or more of said objects from the conveyor arrangement; and
outputting, using a processing system, one or more command signals to the robotic picker arrangement to position one of said robotic pickers relative to the conveyor arrangement to permit said robotic picker to pick up the selected object to be picked and/or sorted from the conveyor arrangement.
